(19) United States
(12) Patent Application Publication
(10) Pub. No.: US 2004/0055174 A1
(43) Pub. Date: Mar. 25, 2004

(54) Tape measure with true and reduced scales for contractor's convenience and accuracy

(76) Inventor: William J. Hirsch JR., Morrisville, NC (US)

Correspondence Address: William J. Hirsch Jr., 200 Benwell Court, Morrisville, NC, 27560, US

(21) Appl. No.: 10/251,189

(22) Filed: Sep. 20, 2002

(51) Int. Cl. G01B 3/10

(52) U.S. Cl. 33/759

(57) ABSTRACT

A tape measure for measuring the distance between a first point and a second point. The tape has a flexible, elongated blade. The blade has a plurality of sets of markings and numbers imprinted thereon which correspond to units of measure. The first set of markings consist of true-size indicia for measuring true distances. The second and subsequent sets of markings consist of indicia divided at increments thereon to be utilized for measuring distances directly from drawings prepared at a reduced scale. The tape measure provides a single tool for measuring distances from reduced scale drawings without making calculations and also for measuring true-size distances in construction layout. Construction errors and delays are reduced through the use of this combination device.

### BACKGROUND

1. Field of Invention

This invention relates to measuring devices, specifically measuring devices such as retractable, coilable tape measures used in building construction trades and measuring scales used to make direct measurements on reduced scale drawings.

2. Prior Art

Builders and contractors routinely utilize retractable, coilable tape measures of various lengths and designs to measure and layout construction work. FIG. 1 shows a typical prior-art tape measure.

Some of these tape measures are marked in the English system of feet and inches. Some are marked in an engineer's nomenclature of feet, tenths of feet, and hundredths of feet. Other tape measures are marked in metric units. These tape measures are marked at the true dimension indicated by the markings. For example, the marking for one foot is actually one foot from the beginning of the tape.

Tape measures used for construction work are commonly longer than five feet in length and are available in lengths of more than one hundred feet. These construction-type tape measures are designed for use in laying out and executing the construction work. Construction-type tape measures are not designed for measuring distances directly from construction drawings that have been prepared at a reduced scale and construction-type tape measures provide no markings for this task.

Builders and contractors often work from drawings that have been prepared at a reduced scale. Commonly used scales for United States architectural drawings include, but are not limited to, ¼″=1′0″, ⅛″=1′0″, ⅜″=1′0″, and others. Commonly used scales for engineering drawings include, but are not limited to, 1″=10′, 1″=20′, 1″=30′, and others. Drawings prepared according to the metric system are drawn at scales appropriate to that system.

During the process of construction, builders and contractors frequently find it necessary to measure distances directly from the reduced scale drawings. This practice is common in planning, estimating, and constructing the work.

Instruments designed for the purpose of measuring distances from scaled drawings are well known and have been available for many years. Such devices are known as architect's scales, engineer's scales, blueprint scales, and drawing scales. These instruments are most commonly rigid rules, six to twelve inches in length. FIG. 2 shows a rigid scale that is triangular in cross section. FIG. 3 shows a rigid scale that is nearly flat in cross section. These instruments are often marked with a variety of drawing scales, including full-sized inches and fractions of inches. Such instruments are limited in use to measuring distances on scaled drawings and are not useful for laying out construction work due to the short length of the instrument. Such instruments are not commonly carried by builders and contractors. Thus, these instruments are not readily available when the builder or contractor needs to measure directly from the scaled drawings. It is on these occasions that the builder or contractor attempts to use a full-sized tape measure (FIG. 1), to measure directly from the reduced scale drawings. They must then make mental calculations to convert the full-sized measurement made on the drawings to a scaled value represented by the reduced scale drawings.

An example of this task would be a case where the user of a conventional tape measure measures an object drawn on a drawing that was prepared at a reduced scale of ¼″=1′0″. In this example, assume that the object measures an actual size of 2⅞″ on the drawing. In order to determine the actual dimension represented by this distance at a scale of ¼″=1′0″, the user must calculate how many quarter-inch increments are contained in 2⅞″. In this case, the total would be eleven quarter-inch increments, with a remainder of ⅛″. The user would conclude that the eleven quarter-inch increments indicate eleven feet and the remaining ⅛″ represents one half of a foot, or six inches. Thus, the distance of 2⅞″ drawing distance measured from a ¼″=1′0″ drawing represents eleven feet and six inches of actual distance.

This type of calculation is difficult, time consuming, and prone to error. Drawings with other scales, such as ⅜″=1′0″, where an inch is not evenly divisible by the fraction of an inch that represents a foot, are very difficult to measure from the drawing and calculate using this method. Costly inaccuracies and delays in the progress of the work are the result.

Common tape measures (FIG. 1) have been improved in the past. Many of the improvements relate to the mechanical function of the device—see, for example, U.S. Pat. No. 3,942,738 (1976) to Rutty, U.S. Pat. No. RE36,887 (2000) to Goldman, U.S. Pat. No. 4,649,649 (1987) to Fain, and U.S. Pat. No. 6,243,964 (2001) to Murray. None of these improvements aid in the task of measuring from reduced scale drawings.

Improvements to the markings on tape measures have been developed. Some examples are U.S. Pat. No. 3,270,421 (1966) to Jones, U.S. Pat. No. 5,875,557 (1999) to Ueki, U.S. Pat. No. 5,913,586 (1999) to Marshall and U.S. Pat. No. 5,894,677 (1999) to Hoffman. All of these examples provide markings for ease of use, but such markings are used to measure distances at true size and provide no benefit in the task of measuring from drawings prepared at a reduced scale.

U.S. Pat. No. 1,643,166 (1927) to Martin discloses improvements to the markings of tape measures by providing roof framing layout data on the reverse side of the tape. Although this information is helpful in the construction of roofs, this added information offers no help in the measurement of scaled drawings.

Improvements to drawing scales have been offered. Examples are shown in U.S. Pat. No. 4,484,395 (1984) to Samuels, U.S. Pat. No. 5,020,233 (1991) to Syken, U.S. Pat. No. 6,061,920 (2000) to McMorrow, and U.S. Pat. No. 6,145,210 (2000) to Walczynski. These improvements aid in the use of drawing scales for measuring distances directly from reduced scale drawings. Many of these devices provide true-size and reduced-size indicia. Such devices are rigid. This rigidity limits their length, since it is cumbersome and impractical to carry and use a rigid tool that is longer than a few feet. In construction, distances of more than a few feet are routinely measured. The limitation in the length of these rigid tools makes them useless in laying out construction work. For that reason, these devices are rarely carried on the job site by builders and contractors.

Longer architect's and engineer's scales are also offered. U.S. Pat. No. 2,692,437 (1954) to Cook discloses a coilable, retractable tape, marked for use in scaling distances from military field maps. This device offers no reduced scales for construction drawings. An architect tape measure, FIGS. 4 and 5, manufactured by JC Industries, Inc, Camarillo, Calif., and sold under the trademark, Pocket Pal, consists of a coilable, retractable, thirty-six-inch-long tape, marked with a ¼″=1′0″ scale on one side and a ⅛″=1″0″ scale on the other, and is limited in length to 36″. FIG. 4 shows the obverse side the Pocket Pal and FIG. 5 shows the reverse side of the Pocket Pal. Both of these devices, and others like them, aid in measurement from reduced scale drawings, but because no true-size markings are provided on either tape, these devices are not useful in the tasks of laying out construction work or measuring distances at true-size.

### SUMMARY OF INVENTION

Accordingly, several objects and advantages of the present invention are:

(a) to provide an improved measuring instrument.

(b) to provide a device that is both useful for measuring true distances in construction work and is also useful in measuring distances directly from drawings that have been drawn at a reduced scale,

(c) to provide a conventional, retractable, coilable tape measure, marked with customary, true-sized indicia, in combination with a set or sets of indicia at common drawing scales,

(d) to provide a conventional, retractable, coilable tape measure, marked with customary, true-sized indicia, in combination with useful markings for measuring distances directly from drawings that have been drawn at a reduced scale,

(e) to provide a measuring device that can be conveniently carried on the job site by builders and contractors that is both useful for measuring true distances in construction work and is also useful in measuring distances directly from drawings that have been drawn at a reduced scale, and

(f) to provide a device that will reduce errors and delays in the work that is both useful for measuring true distances in construction work and is also useful in measuring distances directly from drawings that have been drawn at a reduced scale.

Still further objects and advantages of my invention will become apparent from a consideration of the ensuing description and drawings.

In accordance with the present invention a coilable, retractable tape measure is marked with indicia at true size, in combination with indicia marked at scales useful for measuring distances directly from drawings prepared at reduced scales. The present invention provides a single tool to the builder for interpreting the construction drawings and making the necessary measurements in the process of laying out and constructing the work.

### DESCRIPTION OF DRAWINGS

FIG. 1 is a perspective view of a prior-art tape measure having true-size indicia.

FIG. 2 is a perspective view of a prior-art rigid drawing scale, triangular in section, having a plurality of indicia divided at common drawing scales.

FIG. 3 is a perspective view of a prior-art rigid drawing scale, flat in section, having a plurality of indicia divided at common drawing scales.

FIG. 4 is a perspective view showing the obverse side of a prior-art, coilable, retractable, tape measure having one architectural scale imprinted thereon.

FIG. 5 is a perspective view showing the reverse side of a prior-art, coilable, retractable, tape measure having one architectural scale imprinted thereon.

FIG. 6 is a perspective view showing the obverse side of a coilable, retractable, tape measure, having true-size indicia imprinted thereon in accordance with a first embodiment of the invention.

FIG. 7 is a perspective view showing the reverse side of a coilable, retractable, tape measure, having a plurality of indicia, divided at architectural, engineering or specialty scales imprinted thereon in accordance with a second embodiment of the invention.

FIG. 7A is a perspective view showing a reduced scale drawing, demonstrating the use of the device for measuring feet.

FIG. 7B is a perspective view showing a reduced scale drawing, demonstrating the use of the device for measuring feet and inches.

FIG. 8 is a fragmentary plan view of the obverse side of a tape measure having true-sized indicia imprinted thereon in accordance with a third embodiment of the invention.

FIG. 9 is a fragmentary plan view of the reverse side of a tape measure having indicia divided at architectural scales imprinted thereon in accordance with a fourth embodiment of the invention.

FIG. 10 is a fragmentary plan view of the reverse side of a tape measure having indicia divided at engineering scales imprinted thereon in accordance with a fifth embodiment of the invention.

FIG. 11 is a fragmentary plan view of the reverse side of a tape measure having indicia divided at specialty scales imprinted thereon in accordance with a sixth embodiment of the invention.

FIG. 12 is a fragmentary perspective view of an applied strip (partially applied) having reduced scale indicia imprinted thereon for attachment to the reverse side of an existing tape measure.

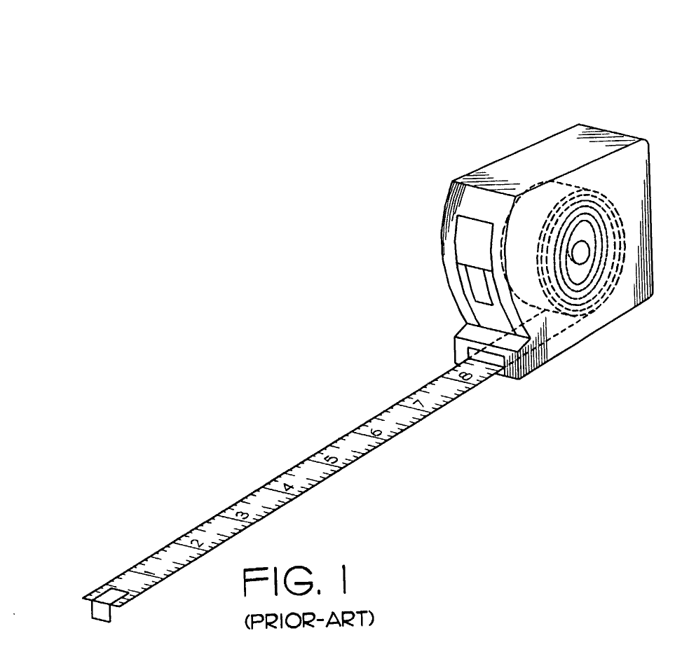

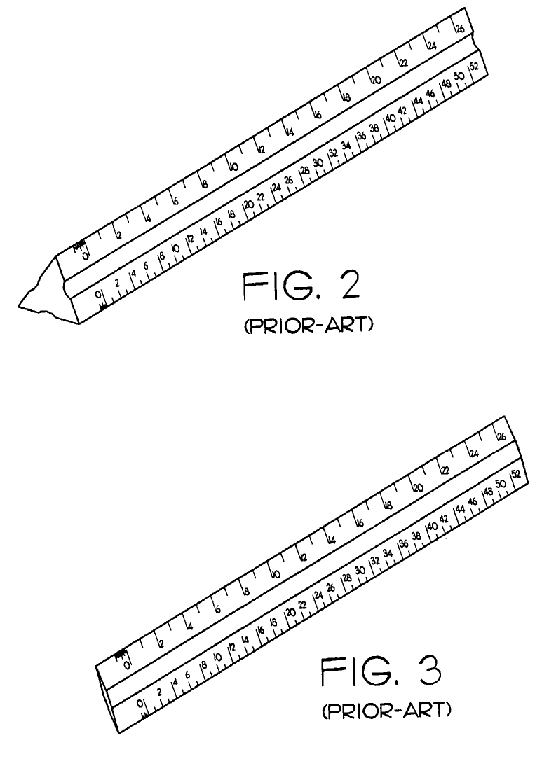

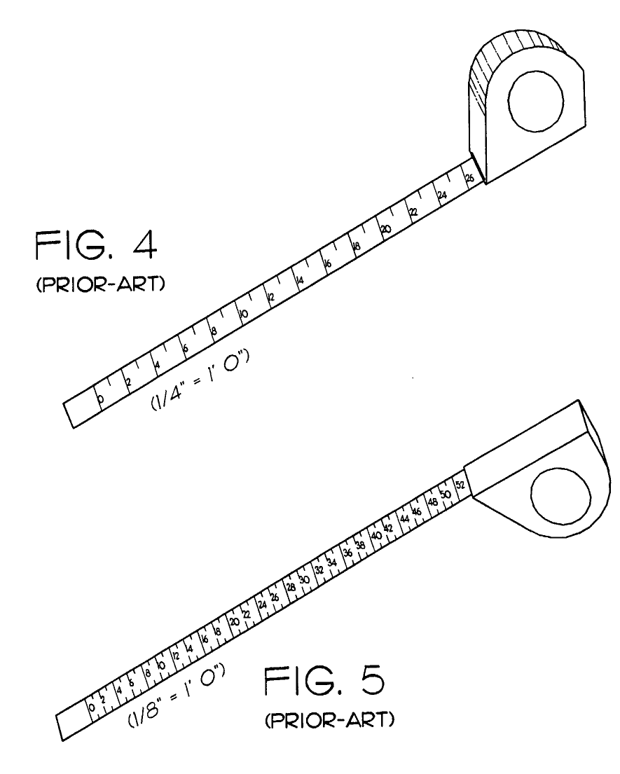

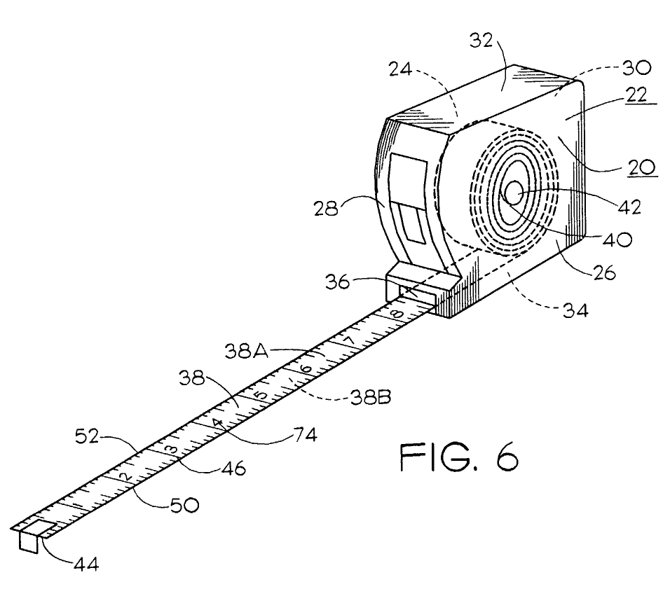

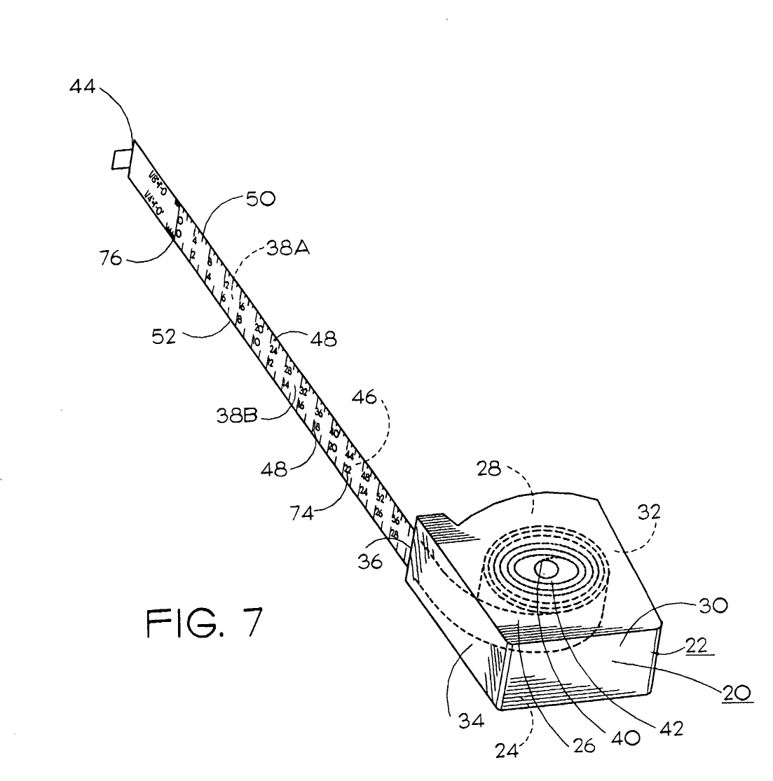

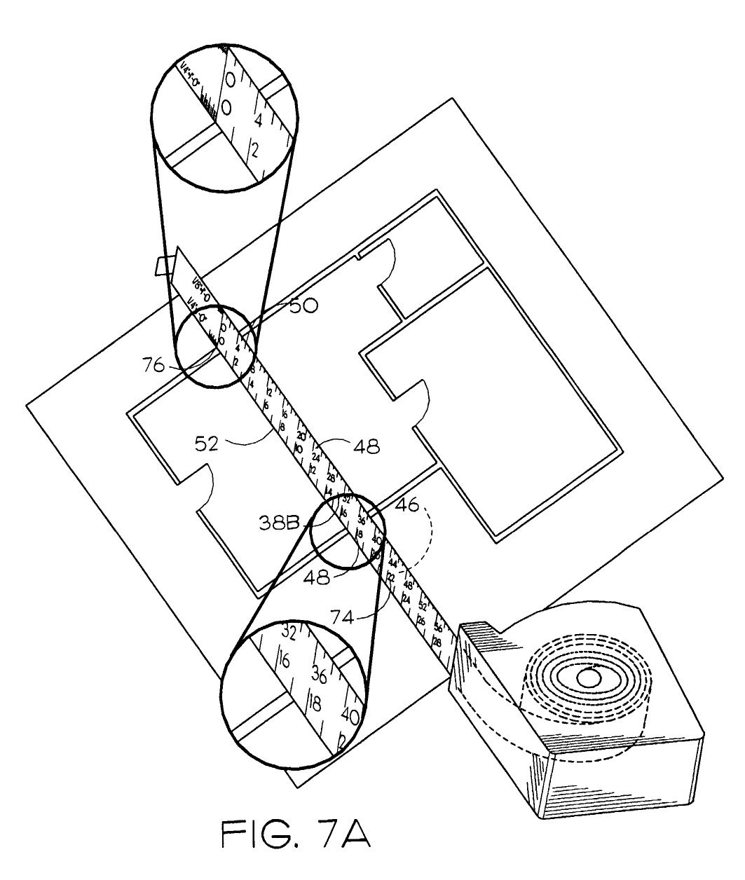

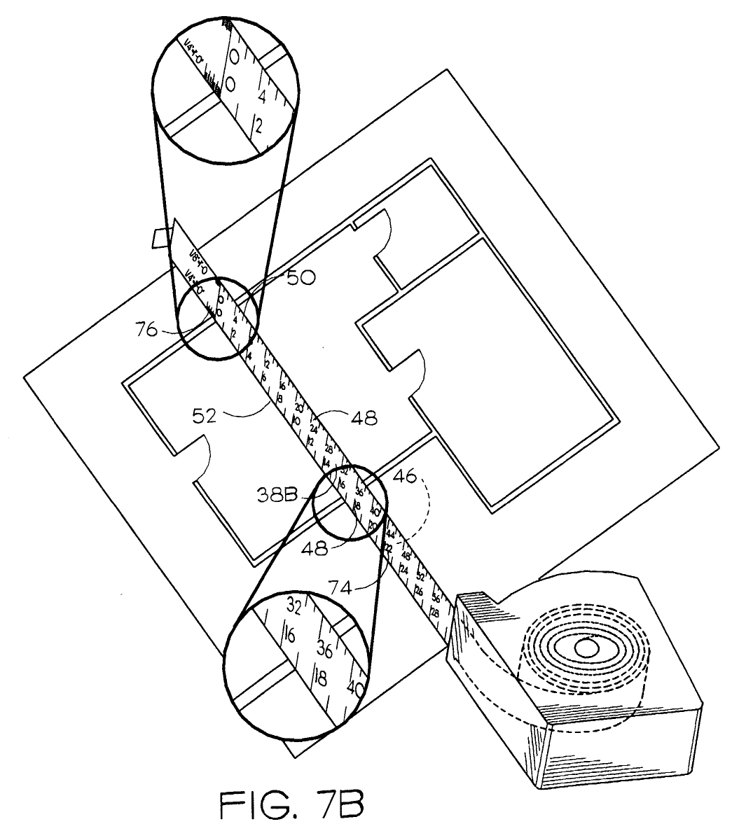

### DETAILED DESCRIPTION—FIGS. 6 AND 7—PREFERRED EMBODIMENT

A preferred embodiment of the coilable, retractable tape measure is illustrated in FIG. 6 (perspective view of obverse) and FIG. 7 (perspective view of reverse). A measuring tape 20 comprises a housing 22 having opposed side walls 24 and 26, opposed front and back walls 28 and 30, and opposed top and bottom walls 32 and 34. The housing has a tape outlet 36 on front wall 28 out of which a flexible measuring blade 38 may be extended.

Measuring blade 38 comprises a flexible, coilable strip. A fixed end 40 of measuring blade 38 is fixed to and coiled into a roll around a tape hub 42 centrally located inside housing 22. A free end or reference end 44 of blade 38 extends through the tape outlet 36. Reference end 44 has a tab 46 fixed for temporarily and removably hooking reference end 44 to a reference point or object and preventing complete retraction of blade 38 into housing 22.

Obverse side 38A of measuring blade 38 illustrated in FIG. 6 has true-size indicia 46 (1″=1″, in this example), illustrated in FIG. 8. Indicia 46 may be marked in increments according to the English or metric system. Indicia 46 may be imprinted along edge 50 of blade 38, along an opposing edge 52 of blade 38, along both edges 50 and 52.

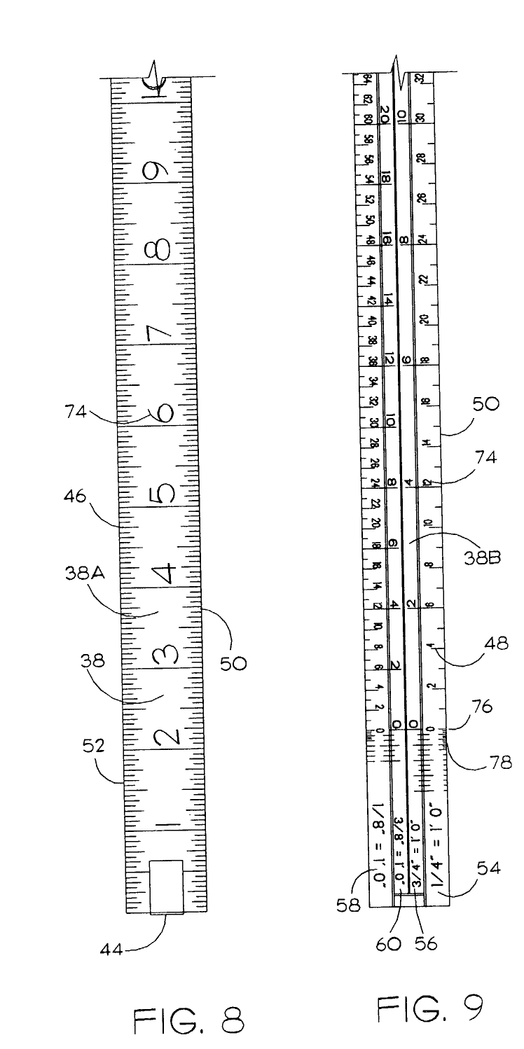

Reverse side 38B of blade 38, illustrated in FIG. 7, has reduced scale indicia 48 imprinted along both edges 50 and 52 as shown. Indicia 48 are illustrated in more detail in FIGS. 9, 10, and 11.

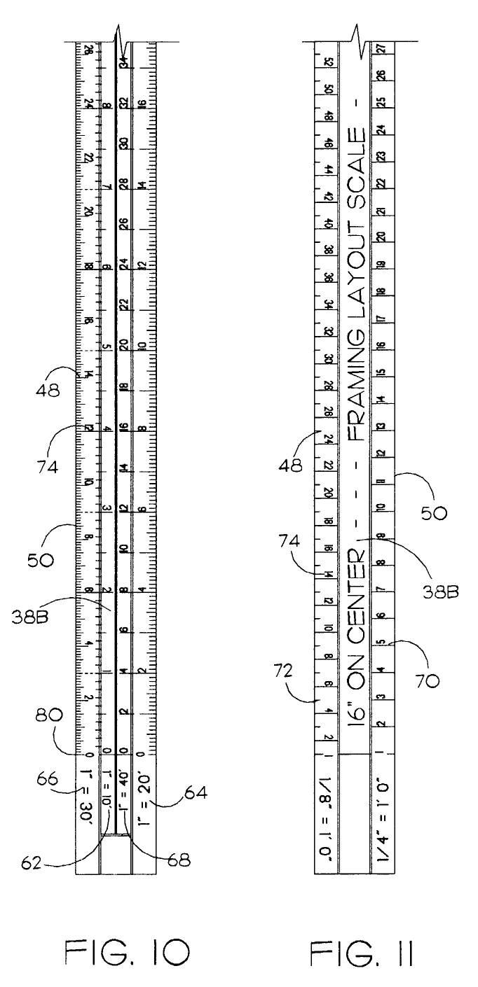

FIG. 9 shows reduced scale indicia 48 divided at a plurality of common architectural scales, specifically at a ¼″=1′0″ scale 54, a ¾″=1′0″ scale 56, a ⅛″=1′0″ scale 58 and a ⅜″=1′0″ scale 60. FIG. 10 shows reduced scale indicia 48 divided at a plurality of common engineering scales, a 1″″=10′ scale 62, a 1″=20′ scale 64, a 1″=30′ scale 66 and a 1″=40′ scale 68. FIG. 11 shows reduced scale indicia 48 divided at a plurality of specialty scales, at ¼″=1′0″ scale with markings at 16″ increments 70, and at a ⅛″=1′0″ scale with markings at 16″ increments 72.

Any number or type of reduced scale indicia 48 can be imprinted on blade 38. Also any method of imprinting or graphic style of indicia 46, indicia 48, or numerals 74 identifying indicia 46 and 48 may be used.

Indicia 48 may or may not commence at reference end 44 and may be situated at any point along blade 38. The length of reduced scale indicia 48 may vary from that shown.

The manner of using this coilable, retractable, true-size tape measure is identical to that for conventional, retractable, true-size tape measures in present use. Namely, one extends blade 38 from the housing. Next, while referring to side 38A, one places reference end 44 at a point by temporarily attaching or holding it at a first point. Next the user extends blade 38 to the second point and reads true-size indicia 46 at the second point, thus determining the distance from the first point to the second point in conventional fashion.

When an architect or contractor needs to measure a distance directly from an architectural drawing, an architect's scale is used. The manner of using the reduced or architect's scale indicia on reverse side 38B is as follows. FIG. 7A shows an example of the method of measurement from an architectural drawing. One first determines at what scale the drawing has been drawn. Next, referring to reverse side 38B, one extends blade 38 to expose the desired scale on side 38B. Next, one places the architect's scale zero point 76 of the appropriate scale at the first point and positions the scale such that edge 50 or opposing edge 52 upon which the remaining numerals 74 are imprinted pass over the second point. Next, one reads the nearest numeral 74 to the second point. The example in FIG. 7A shows that the second point lies between indicia marked 18 and indicia unmarked, but representing 17. Should no numeral 74 align perfectly with the second point, as in this example, one slides the scale laterally (FIG. 7B), to the closest numeral 74 or reduced scale indicia 48 of the next smaller whole value, the indicia representing 17 in the example. When the scale is moved to this smaller, nearby numeral 74, the zero point 76 of the scale moves away from the first point (FIG. 7B). The smaller, whole numeral 74, now located on the second point, determines the number of feet in the distance being measured, 17 feet in the example. Next, one reads the number of inch values 78 between the first point and the architect's scale zero point 76 to determine the number of inches in addition to the whole feet that are being measured, 4 inches in the example. The total distance measured in the example in FIG. 7B is 17′4″.

When an engineer, architect, contractor or other user needs to measure distance directly from engineering drawings, such as site plans or landscape plans, engineer's scale is used. To use the engineer's scale, one first determines at what scale the drawing has been drawn. Next, one places the scale's zero point 76 (using the appropriate scale) at the first point and positions edge 50 or opposing edge 52 upon which the remaining numerals 74 are imprinted pass over the second point. Next, one reads the nearest numeral 74 and any unmarked reduced scale indicia 48 to the second point to determine the distance being measured.

Specialty scales shown in FIG. 11 are used in a manner similar to use of an engineer's scale. Other such specialty scales would be used in the manner for which they were designed.

In an additional embodiment, housing 22 can be omitted (not shown). This embodiment is in effect a replacement measuring blade 38 for existing tape measures.

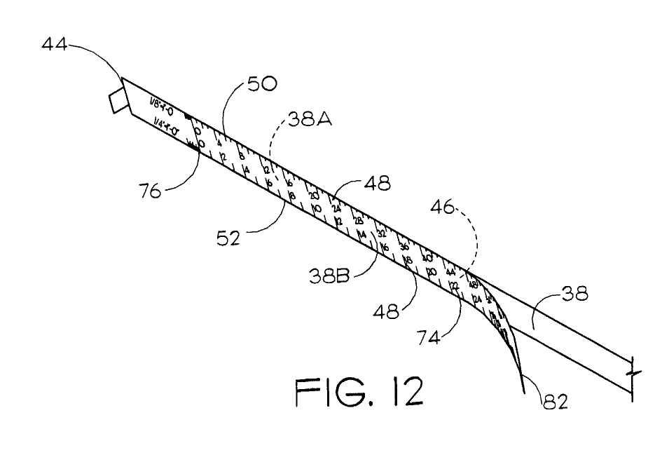

An additional embodiment, shown in FIG. 12, consists of an attachable strip 82 of cloth, plastic, tape, or film, imprinted with scales appropriate for measuring distances directly from drawings prepared at a reduced scale. Strip 82 may be attached to a common tape measure blade 38 marked with true-size indicia. Strip 82 may be attached by any means, such as adhesives or static charge to the reverse of blade 38 of the common tape measure. Attachment of strip 82 would create the combination claimed herein.

From the description above, a number of advantages of the coilable, retractable tape measure embodying a combination of true-size indicia with indicia marked at a reduced scale become evident:

(a) A builder or contractor may conveniently measure distances directly from a reduced scale drawing and measure true distances in the process of the actual construction by means of the same tool.

(b) The use of this device by a builder or contractor on the construction site removes his or her need to carry an architect's, engineer's, or specialty scale. Such tools are not commonly carried by builders and contractors.

(c) This combination of a tape measure, a tool commonly carried by a builder, with reduced scale measuring devices, tools not commonly carried by a builder, facilitates the task of laying out construction work by providing the two essential tools needed for this task in one device. The use of this device eliminates the task of making calculations when measuring from construction drawings.

(d) Costly errors and delays caused by the need to calculate measuring conversions when measuring from reduced scale drawings will be eliminated.

Accordingly, it will be seen that the benefit of the use of this device is to ease the task of taking numerous measurements from reduced scale plans, associated with construction. The combination herein provides a readily useable and conveniently carried tool for the dual purpose of measuring true size distances and distances on reduced scale drawings.

The use of this device eliminates the need for a builder or contractor to make calculations when measuring from drawings drawn at a reduced scale. Costly mathematical errors will be eliminated. Valuable construction time will be saved.

While the above description contains many specificities, these should not be construed as limitations on the scope of the invention, but rather as an exemplification of preferred embodiments thereof. Many other variations are possible. For example, the marking of the indicia for both true size and reduced scale could be printed in many different formats, as appropriate for other types of construction or measuring needs. Variations can be made in numeral position, orientation, color, and style to enhance legibility and visibility of the markings. Variations can be made in color and style to enhance legibility and visibility of the markings. The measuring blade could be of any length. The housing can take different forms for different applications. Various coiling mechanisms may be utilized. The measuring blade can be fabricated of metal, cloth, plastics, other composites, etc. A single reduced scale or a plurality of reduced scales can be imprinted on the measuring blade. Various designs and colors can be used to improve the aesthetics of the device. Mechanical changes can be made to the design of the tape, housing and means of coiling and retraction.

Although the foregoing is provided for the purposes of illustrating, explaining and describing embodiments of the present invention, modifications and adaptations to these embodiments will be apparent to those skilled in the art and may be made without departing from the scope or spirit of the invention. Accordingly, the scope of the invention should be determined not by the embodiment(s) illustrated, but by the appended claims and their legal equivalents.

I claim:

1. In combination, a measuring tape having a scale for measuring distances at a true size and a scale for measuring distances at a reduced scale, said scale for measuring distances at a true size comprising a series of measurement markings whose spacing is indicated by indicia adjacent said markings which give the actual spacing of said markings in a scale of measurement, said scale for measuring distances at a reduced scale comprising a series of markings whose spacing is indicated by indicia adjacent said markings which give the reduced scale spacing of said markings in a reduced scale of measurement, whereby said reduced scale markings are used for measuring distances from construction drawings prepared at a reduced scale and said true-size markings are used for measuring true distances in actual construction, eliminating calculations and reducing errors.

2. The measuring tape in claim 1 wherein said measuring tape is mounted in a housing in a coiled form.

3. The measuring tape in claim 1 comprising a blade of flexible, coilable material.

4. The measuring tape in claim 1 wherein said indicia spaced at increments of feet, inches, and fractions of inches at said true and actual sizes.

5. The measuring tape in claim 1 wherein indicia are spaced at increments according to the metric system at said true and actual size.

6. The measuring tape in claim 1, further including a plurality of reduced drawing scales imprinted on said blade.

7. The measuring tape of claim 6 wherein said tape includes said reduced drawing scale for directly measuring distances in feet, tenths of feet and hundredths of feet on drawings made to a reduced scale.

8. The measuring tape of claim 6 wherein said tape includes said reduced scale for directly measuring distances in metric units on drawings made to a reduced scale.

9. The measuring tape of claim 6 wherein said tape includes said reduced scale for directly measuring distances at special increments on drawings made to a reduced scale.

10. In a coilable, retractable tape measure comprising a measuring blade and a housing having true-size indicia imprinted on one side of the measuring blade, the improvement wherein at least one set of reduced scale indicia are imprinted on an opposed side of said measuring blade, said scale for measuring distances at a true size comprising a series of measurement markings whose spacing is indicated by indicia adjacent said markings which give the actual spacing of said markings in a scale of measurement, said scale for measuring distances at a reduced scale comprising a series of markings whose spacing is indicated by indicia adjacent said markings which give the reduced scale spacing of said markings in a reduced scale of measurement, whereby said reduced scale markings are used for measuring distances from construction drawings prepared at a reduced scale and said true-size markings are used for measuring true distances in actual construction, eliminating calculations and reducing errors.

11. The measuring tape of claim 10 wherein measuring tape is mounted in a housing in a coiled form.

12. The measuring tape of claim 10 wherein said indicia are spaced at increments of feet, inches and fractions of inches at said true and actual sizes.

13. The measuring tape of claim 10 wherein said indicia are spaced at increments according to the metric system at said true and actual size.

14. The measuring tape of claim 10, further including a plurality of reduced drawing scales imprinted on said blade.

15. The measuring tape of claim 14 wherein said reduced scale indicia are spaced and marked for directly measuring distances in feet and inches on drawings made to a reduced scale

16. The measuring tape of claim 14 wherein said reduced scale indicia are spaced and marked for directly measuring distances in feet on drawings made to a reduced scale

17. The measuring tape of claim 14 wherein said reduced scale indicia are spaced and marked for directly measuring distances in metric units on drawings made to a reduced scale

18. The measuring tape of claim 14 wherein said reduced scale indicia are spaced and marked for directly measuring distances at special increments on drawings made to a reduced scale.
